(19) United States
(12) Patent Application Publication
(10) Pub. No.: US 2018/0366778 A1
(43) Pub. Date: Dec. 20, 2018

(54) SYSTEMS AND METHODS FOR PREPARING SOLID ELECTROLYTE INTERPHASES FOR ELECTROCHEMICAL ENERGY STORAGE DEVICES

(71) Applicant: Ioxus, Inc., Oneonta, NY (US)

(72) Inventors: Xiaorong Liu, Oneonta, NY (US); Ken Rudisuela, Grimsby (CA); Yuichi Katoh, Kyoto (JP)

(21) Appl. No.: 16/008,414

(22) Filed: Jun. 14, 2018

Related U.S. Application Data
(60) Provisional application No. 62/519,491, filed on Jun. 14, 2017.

(51) Int. Cl. H01M 10/0562; H01M 10/0525; H01M 4/62; H01G 9/025

(52) U.S. Cl. CPC H01M 10/0562; H01M 10/0525; H01M 4/622; H01M 2004/028; H01M 2300/0082; H01M 2300/008; H01G 9/025

(57) ABSTRACT

Embodiments described herein relate generally to a system and methods for preparing engineered solid electrolyte interphases for electrochemical energy storage devices. Some of the engineered SEI layers include passivation films, some of the engineered SEI layers include polymerization films, and some SEI layers include both passivation and polymerization layers.

### CROSS-REFERENCE TO RELATED APPLICATION

This application claims the priority benefit, under 35 U.S.C. 119(e), of U.S. Application No. 62/519,491, entitled “SYSTEMS AND METHODS FOR PREPARING SOLID ELECTROLYTE INTERPHASES FOR ELECTROCHEMICAL ENERGY STORAGE DEVICES” and filed on Jun. 14, 2017, the disclosure of which is hereby incorporated by reference in its entirety.

### TECHNICAL FIELD

The present disclosure relates generally to systems, apparatus, and methods for preparing solid electrolyte interphases, and more particularly to forming engineered solid electrolyte interphases on the electrodes of electrochemical energy storage devices.

### BACKGROUND

As the demand for better performing electrochemical energy storage devices increases, for example, for devices that last longer and are more stable, and for devices with higher storage capacity and energy density, improvements in some aspects of the electrochemical energy storage technology are needed to meet these criteria.

One of the most dominant electrochemical energy storage technologies currently available is based on lithium ion technology. The underlying electrochemical reaction involved in this technology is the movement of lithium ions between a positive electrode and a negative electrode. In theory, this mechanism should work forever, but devices using this technology lose their performance over time, i.e., with cycling, due to loss of lithium ions and/or degradation of some of the components in the devices. Most devices are projected to maintain a fraction of their initial capacity after a few hundred charge/discharge cycles. Therefore, improvements are needed to delay the capacity drop by substantially preventing or retarding the lithium loss and/or the degradation of working components in lithium ion devices.

### SUMMARY

Embodiments described herein relate generally to a system and methods for preparing solid electrolyte interphases for electrochemical energy storage devices. The SEIs are engineered to maximize cycle life and to increase thermal stability of the devices by minimizing gas generation and electrolyte decomposition. The engineered SEIs can be formed by customizing electrolyte additives and constituent lithium salts to create functional passivation films and/or functional polymerization films.

In some embodiments, an electrochemical energy storage device comprises a cathode, a pre-lithiated anode having an engineered solid electrolyte interphase disposed thereon, a separator disposed between the cathode and the pre-lithiated anode, and an electrolyte including an electrolyte additive.

In some embodiments, an electrochemical energy storage device comprises a cathode, a pre-lithiated anode having an engineered solid electrolyte interphase disposed thereon, the engineered solid electrolyte interphase including at least one of a passivation layer and a polymerization layer, a separator disposed between the cathode and the pre-lithiated anode; and an electrolyte including an electrolyte additive.

In some embodiments, a lithium-ion capacitor (LiC) comprises a cathode, the cathode including a first substrate, a first carbon, and a first binder, a pre-lithiated anode including a second substrate, a second carbon, and a second binder, the pre-lithiated anode having an engineered solid electrolyte interphase disposed thereon, the engineered solid electrolyte interphase including at least one of a passivation layer and a polymerization layer, a separator disposed between the cathode and the pre-lithiated anode, and an electrolyte including a solvent and an electrolyte additive.

In some embodiments, a method of forming an engineered solid electrolyte interphase for an electrochemical energy storage device comprises providing an electrolyte, a first electrode and a second electrode, the first electrode having excess of lithium ions relative to the second electrode, adding an additive to an electrolyte, and forming the engineered solid electrolyte interphase on the first electrode and the second electrode.

In some embodiments, a method of forming an engineered solid electrolyte interphase for an electrochemical energy storage device comprises providing an electrolyte, a first electrode and a second electrode, the first electrode having excess of lithium ions relative to the second electrode, adding a first additive to an electrolyte, forming a first engineered solid electrolyte interphase on the first electrode and second electrode, adding a second additive to the electrolyte, and forming a second engineered solid electrolyte interphase on the first engineered solid electrolyte interphase.

In some embodiments, a method of producing a lithium-ion capacitor (LiC) including an engineered solid electrolyte interphase comprises providing a cathode, the cathode including a first substrate, a first carbon, and a first binder, providing a pre-lithiated anode including a second substrate, a second carbon, and a second binder, disposing a separator between the cathode and the pre-lithiated anode, adding electrolyte including a solvent and an electrolyte additive, and forming an engineered solid electrolyte interphase on at least one of the cathode and the pre-lithiated anode, the engineered solid electrolyte interphase including at least one of a passivation layer and a polymerization layer.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, methods, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

FIG. 1 shows a schematic block diagram of an engineered solid electrolyte interphase for improving electrochemical performance of an electrode, according to an embodiment.

FIG. 2 shows an exemplary process flow diagram for preparing an engineered solid electrolyte interphase on an electrode, according to an embodiment.

### DETAILED DESCRIPTION

Embodiments described herein generally relate to systems and methods for improving the performance of electrochemical energy storage devices, and more particularly for preparing solid electrolyte interphases for electrochemical energy storage devices.

One of the main reasons electrochemical cells (e.g., lithium-ion batteries, lithium-ion capacitors, etc.) lose their original capacity is due to the consumption of lithium ions during device operation. When lithium ions are shuttled back and forth between two opposing electrodes, some lithium ions are consumed during the decomposition of electrolyte molecules. Particularly, anodes suffer from irreversible capacity loss at the cell formation stage where the lithium ions are consumed during the reaction with electrolyte that results in the formation of the solid electrolyte interphase (SEI). Although some of the irreversible lithium loss occur in the beginning (during the cell formation stage that leads to formation of the SEI), additional lithium ions are continuously consumed along with, and during, the decomposition of electrolyte with repeated charge/discharge cycles. This process can continue during the entire life cycle of the devices as the SEI continues growing at the expense of consumed lithium ions and decomposed electrolyte.

As the SEI continues growing on the electrodes, the physical and electrochemical properties of the SEI, which interfaces between the electrodes and the electrolyte, continue changing. Since the SEI is an ionic conductor and an electrical insulator, the increased size of the SEI can lead to a higher electrical resistance, which increases the temperature of the device during operation. In addition, the shift in the electrochemical potential due to varying available lithium ions, changing electrolyte concentration, and the effect of the enlarged SEI can result in an overall decreased cycle life and a general instability of the device. Said another way, this “degradation” can lead to formation of a “bad” SEI, which can be a significant cause for capacity drop, shortened cycle life, and thermal instability of all lithium ion-based devices. Therefore, one way to prevent the shortcomings of current lithium ion-based energy storage technology is to engineer the SEI by minimizing lithium ion consumption and electrolyte decomposition so as to maximize cycle life and to increase thermal stability of the devices. The engineered SEIs can be formed by customizing the electrolyte additives and optionally adding certain lithium salts to create targeted passivation films and/or polymerization films as described herein.

Although all lithium ion-based devices use lithium ions, there are different energy storage mechanisms for anodes and cathodes, depending on the device technology. For some cathodes, lithium ions transported by electrolyte are stored on the internal surface between the electrodes and the electrolyte, while some anodes store energy by electrochemical reactions. For hybrid devices, such as lithium-ion capacitors (LiCs), the electrodes are unique. Considered a hybrid energy storage system, LiCs can combine advantages of lithium ion batteries (LiBs) and electrochemical double layer capacitors (EDLCs). For example, LiCs can have an energy density of about 2-4 times that of EDLCs and can operate at a higher voltage (up to 3.8 V) similar to those of LiBs. Due to the use of pre-lithiated anodes, LiCs can also have a similar cycle life as the EDLCs.

In some embodiments, the operating voltage of LiCs, which ranges from 2.2 V to 3.8 V, can create an electrochemical reduction environment conducive for electrolyte to decompose during cycling. In some embodiments, the decomposition of electrolyte is accompanied by gas generation from the decomposition reaction. In order to suppress gas generation and electrolyte decomposition, appropriate electrolyte additives can be added to the electrolyte so as to form a desired SEI. Said another way, electrolyte additives are chosen so that the SEI formed during cycling causes a minimal amount of damage, including thermal instability and capacity drop, to the electrochemical device.

There are generally two types of electrolyte additives available for LiBs that can be useful in engineering the SEI in LiCs. The two types of electrolyte additives are categorized into functional and polymerization types. In some embodiments, the functional type additives are used to form a layer of passivating film. The passivation layer can comprise sulfur-containing chemicals, such as ethylene sulfite (ES), propylene sulfite (PS), and dimethyl sulfite (DMS), which can be reduced at the operating voltage of 2.0 V vs Li⁺/Li reference. In some embodiments, the passivation layers can impede irreversible reactions between the anodes and electrolyte, which can be useful for retarding the growth of unfavorable SEI.

In some embodiments, the polymerization type additives, such as ethyl carbonate (EC), fluoroethylene carbonate (FEC), and vinylene carbonate (VC) can be used to form a polymer protecting layer at a reduction condition for LiBs. A “good” or favorable SEI is mechanically stable and can have excellent high temperature stability. A combination of electrolyte additives may improve cycle life and thermal stability, but the newly formed SEI surfaces can be spontaneously modified by combined additives, resulting in less hierarchy structure of the SEI. This can significantly decrease the effectiveness of the added electrolyte additive, and thus, choosing the right combination of electrolyte additives, i.e., “engineering” the SEI formation is important. If the SEI formation can be designed so as to control its growth, this engineering effort can help delay the decay in the device cycle life and rate of capacity reduction, and can possibly reduce thermal instability issues (i.e., devices catching fire) lingering in current lithium ion-based devices.

In some embodiments, a method of engineering electrolyte additives for lithium ion-based devices is described. In some embodiments, selected electrolyte additives can be utilized for maximizing cycle life and for improving thermal stability of the devices by hierarchy forming the SEI. In some embodiments, a first SEI layer can be formed by either applying electrolyte additives that are more likely to form a passivating SEI or electrolyte additives that are likely to form a polymerizing SEI. In some embodiments, a second SEI layer can be formed by either adding electrolyte additives that are like to form a polymerizing SEI or electrolyte additives that are likely to form a passivating SEI. In some embodiments, the two SEI layers that are created using this approach can be considered an engineered SEI with combined strengths and advantages of the constituting electrolyte additives. In some embodiments, the order and arrangement of the two SEI layers may play a role in its performance in improving the lithium ion-based devices.

In some embodiments, a method of applying electrolyte additives in a specific order for maximizing the function of each electrolyte additive component is described. For example, if a first SEI layer is a passivation layer, the added electrolyte additive or additives can be any sulfur-containing chemicals, including but not limited to ES, PS, and DMS. If a first SEI layer is a polymerization layer, the added electrolyte additive or additives can be any polymerizing chemicals, including but not limited to FEC, VC, and MEC. If the first layer is a passivation layer, then the second layer can be a polymerization layer, and hence appropriate polymerizing chemicals can be added to form the polymerization layer. Likewise, if the first layer is a polymerization layer, then the second layer can be a passivation layer, and hence appropriate passivating electrolyte additives, such as sulfur-containing chemicals can be added to from the passivation layer.

In some embodiments, a mixture of certain selected electrolyte additives can lead to formation of a polymerization layer. In other embodiments, a mixture of certain selected electrolyte additives can lead to formation of a passivation layer. In some embodiments, the engineered SEI that is formed via the two-step bi-layered SEI as described herein can be more stable and more functionally tuned than an SEI that is formed via a conventional method in which all electrolyte additives are added simultaneously in a single step. In some embodiments, the engineered SEI can be more compact and can have at less two separate functional layers which can be more effective in suppressing decomposition of electrolytes than the random structure of the SEI created by the conventional one-step approach.

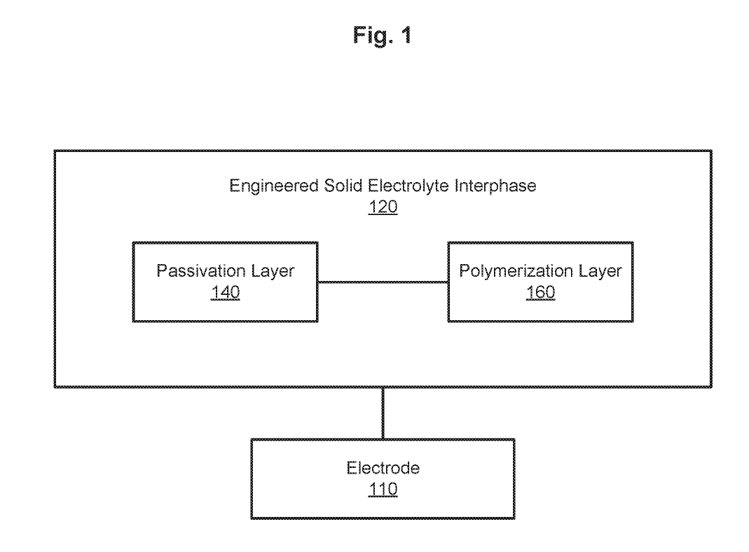

FIG. 1 shows a schematic block diagram of an engineered SEI 120 for improving electrochemical performance of an electrode 110, according to an embodiment. The engineered SEI 120 includes a passivation layer 140 and a polymerization layer 160, which together form the engineered SEI 120 that can be configured to improve the electrochemical performance of the electrode 110.

In some embodiments, the electrode 110 can be any conventional electrodes. In some embodiments, the electrode 110 can be an anode or a cathode. In some embodiments, the electrode 110 can be any conventional anodes. In some embodiments, the electrode 110 can be any carbon containing electrodes. In some embodiments, the electrode 110 can be any electrodes that can be pre-lithiated. In some embodiments, the electrode 110 can have any form factor, including flat, rolled, and multilayer electrode stack.

In some embodiments, the electrode 110 can comprise any carbon based electrode materials, including graphene, graphene sheets or aggregates of graphene sheets, graphite/graphitic or non-graphitic carbon, amorphous carbon, mesocarbon microbeads, boron-carbon alloys, hard or disordered carbon, carbon nanotubes, or mixture of these materials and composites thereof. In some embodiments, the electrode 110 can comprise nitrogen-doped graphene. In some embodiments, the electrode 110 can comprise graphene oxide. In some embodiments, the electrode 110 can include at least one high capacity anode materials selected from silicon, bismuth, boron, gallium, indium, zinc, tin, antimony, aluminum, titanium oxide, molybdenum, germanium, manganese, niobium, vanadium, tantalum, iron, copper, gold, silver, platinum, chromium, nickel, cobalt, zirconium, yttrium, molybdenum oxide, germanium oxide, silicon oxide, silicon carbide, any other high capacity materials or alloys thereof, and any combination thereof. In some embodiments, the electrode 110 can comprise silicon and/or alloys thereof. In some embodiments, the electrode 110 can comprise tin and/or alloys thereof. In some embodiments, the electrode 110 can include one or more from the following metal oxides, including tin oxide, iron oxides, cobalt oxides, copper oxides, titanium oxide, molybdenum oxide, germanium oxide, silicon oxide and any oxides in the lithium titanium oxide (lithium titanate), and any combinations of metal oxides thereof. In some embodiments, the electrode 110 can include one or more from the following transition metal chalcogenides, such as lead sulfide, tantalum sulfide, molybdenum sulfide and tungsten sulfide. In some embodiments, the electrode 110 can include sulfur. In some embodiments, the electrode 110 can include any combination, composites or alloys of the electrode 110 described herein.

In some embodiments, the engineered SEI 120 can include one or more layers of tailored SEI formed from at least one of passivation layers 140 and at least one of polymerization layers 160. In some embodiments, the engineered SEI 120 can comprise a first SEI layer and a second SEI layer. In some embodiments, the engineered SEI 120 can comprise a first SEI layer, a second SEI layer, and additional SEI layers. In some embodiments, the first SEI layer can be the passivation layer 140. In some embodiments, the first SEI layer can be the polymerization layer 160. In some embodiments, the second SEI layer can be the passivation layer 140. In some embodiments, the second SEI layer can be the polymerization layer 160. In some embodiments, the additional SEI layers can be any of passivation layers 140 and polymerization layers 160.

In some embodiments, the engineered SEI 120 can comprise any lithium salts, including but not limited to lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃) or any mixture of these salts.

In some embodiments, the passivation layers 140 can comprise any sulfur-containing chemicals, including but not limited to, ES, PS, and DMS, or a mixture of these chemicals.

In some embodiments, the polymerization layers 160 can comprise any organic solvents, including but not limited to EC, FEC, VC, dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, and 1-fluoro-2-(methylsulfonyl) benzene or a solvent blend including any mixture of these solvents.

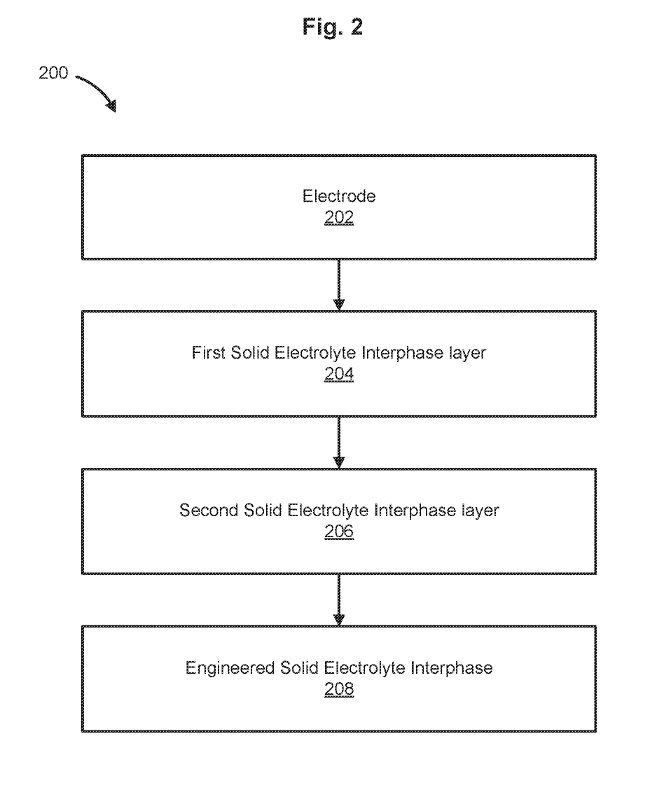

FIG. 2 shows an exemplary process flow diagram describing a method 200 for preparing an engineered SEI on an electrode, according to an embodiment. The preparation method 200 includes forming an electrode, at step 202. The electrode can be formed by any of the conventional and aforementioned electrode manufacturing methods and can comprise any electrode materials described herein. For example, U.S. Patent Publication No. 2009-0080141, U.S. Patent Publication No. 2009-0279230, U.S. Patent Publication No. 2010-0053844, U.S. Patent Publication No. 2010-0079109, U.S. Patent Publication No. 2011-0032661, U.S. Patent Publication No. 2011-0149473, U.S. Patent Publication No. 2011-0271855, U.S. Patent Publication No. 2012-0033347, U.S. Patent Publication No. 2012-0187347, U.S. Patent Publication No. 2014-0002958, U.S. Patent Publication No. 2015-0016021, U.S. Patent Publication No. 2016-0217937, U.S. Patent Publication No. 2016-0254104, and U.S. Patent Publication No. 2017-0301486 disclose electrodes and methods of forming electrodes, the disclosure of all of which are hereby incorporated by reference in their entireties. Therefore, the process of manufacturing the electrode is not described in further detail herein.

Once the electrode is formed, a first SEI layer can be disposed on the electrode, at step 204. In some embodiments, the first SEI layer can be a passivation layer. The passivation layer can be formed by adding an electrolyte additive or a plurality of electrolyte additives, such as sulfur-containing ES, PS, and DMS or a mixture of these chemicals. In some embodiments, the passivation layer can also comprise one of more lithium salts, such as lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃) or any mixture of these salts.

In some embodiments, the first SEI layer can be a polymerization layer. The polymerization layer can be formed by adding an electrolyte additive or a plurality of electrolyte additives, such as organic solvents, including but not limited to EC, FEC, VC, dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, and 1-fluoro-2-(methylsulfonyl) benzene or a solvent blend including any mixture of these solvents. In some embodiments, the polymerization layer can also comprise one of more lithium salts, such as lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃) or any mixture of these salts.

At step 206, a second SEI layer can be disposed on top of the first SEI layer. In some embodiments, the second SEI layer can be a passivation layer. The passivation layer can be formed by adding an electrolyte additive or a plurality of electrolyte additives, such as sulfur-containing ES, PS, and DMS or a mixture of these chemicals. In some embodiments, the passivation layer can also comprise one of more lithium salts, such as lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃) or any mixture of these salts.

In some embodiments, the second SEI layer can be a polymerization layer. The polymerization layer can be formed by adding an electrolyte additive or a plurality of electrolyte additives, such as organic solvents, including but not limited to EC, FEC, VC, dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, and 1-fluoro-2-(methylsulfonyl) benzene or a solvent blend including any mixture of these solvents. In some embodiments, the polymerization layer can also comprise one of more lithium salts, such as lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃) or any mixture of these salts.

In some embodiments, the completion of deposition of the second SEI layer on top of the first SEI layer can result in a finished engineered SEI, at step 208. In some embodiments, the engineered SEI can comprise a passivation layer as the first SEI layer and a polymerization layer as the second SEI layer. In other embodiments, the engineered SEI can comprise a polymerization layer as the first SEI layer and a passivation layer as the second SEI layer. In some embodiments, the engineered SEI can be a compacted combination of two SEI layers.

The following examples illustrate some specific methods for preparing an engineered SEI, according to some embodiments.

In some embodiments, the preparation of anodes is described as followed. First, 5000 g of hard carbon A, 50 g of cellulose, and 225 g of carbon black are mixed for 10 minutes in a 50 L mixer at a mixing speed of 50 rpm. Second, 5000 g of suspension solution comprising styrene-butadiene rubber (SBR) binder and water is added to the mixture. The mixture is then stirred for 30 minutes at the medium speed, and further mixed for 30 additional minutes at a high speed to obtain a smooth hard carbon slurry. The slurry is degassed for at least 20 minutes under vacuum and the resulting slurry is then coated on the surface of a 10-μm copper foil. After drying and pressing, the typical thickness of double-sided electrodes produced is 150 μm.

In some embodiments, the preparation of cathodes is described as followed. First, 5000 g of activated carbon A, 71 g of cellulose, and 476 g of carbon black are mixed for 10 minutes in a 50 L mixer at a mixing speed of 50 rpm. Second, 13880 g of suspension solution comprising polymer binder and water is added to the mixture. The mixture is then stirred for 30 minutes at the medium speed, and further mixed for 30 additional minutes at a high speed. The slurry is degassed for at least 20 minutes under vacuum, and the resulting slurry is then coated on the surface of a 20-μm aluminum foil. After drying and pressing, the typical thickness of double-sided electrodes produced is 220 μm.

### Example 1

The starting materials are the following: 11 pieces of anodes (150 μm, 115 mm by 104 mm) are first welded together using an ultrasound welder. Surfaces of each anode are attached a piece of lithium metal foil for forming an anode/Li stack. The anode/Li stack is then soaked in a laminated aluminum pouch with 1.2 molar LiPF₆ in the solvent mixture comprising EC/DMC/EMC (with the ratio 3/3/4), which also contains 3% ethylene sulfite (ES) for lithiation. After 21 hours, the attached Li metal foils are removed, and the anodes are dried in a glove box filled with argon gas. The pre-lithiated anodes contain a first SEI layer, which is considered a passivation layer due to reduction of the ES additive at around 2.0 V vs Li reference electrode.

Then, 10 pieces of activated carbon cathodes (275 μm, 110 mm by 100 mm) are welded together using an ultrasound welder and dried for 17 hours in a 140° C. vacuum oven. Polyethylene separators are then attached on the surfaces of cathodes.

A cell assembly is carried out in a dry room. The dried pre-lithiated anodes are first inserted into the cathode stack with separators. The resulting stack is then put into a pre-formed laminated pouch, and sealed three of the four sides using a heat sealer. The fourth side is sealed after the pouch is filled with 70 g of 1 molar LiPF₆ in the solvent mixture comprising EC/DMC/EMC (3/3/4), which also contains 2% VC and 2.1 g of hexamethyldisiloxane (HMDS) additives. VC functions as a polymerization additive and gets deposited on the surfaces of the anodes by reduction reactions, resulting in a second SEI layer. HMDS is used as water scavenger which removes trace water contaminations in the electrolyte, electrode surfaces, and separators.

The cell's performance is evaluated by applying a 100 A of charge/discharge current, without any rest time in between the charge and discharge cycle. Its equivalent series resistance (ESR) and capacitance are measured after each 4000 cycles. After each 4000 cycles is completed, the cell is relaxed to cool down for 2 hours. The cell is charged to 3.8 V using a current of 6 A, and its voltage is kept constant at 3.8 V for 20 minutes. The cell's ESR is determined by applying a current pulse. After charging for another 10 minutes, the cell's capacitance is measured by discharging its voltage to 2.2 V at the current of 6 A. The slope of the discharge curves is the capacitance of the cell.

### Example 2

A LiC comprising 19 pieces of anodes (150 μm, 115 mm by 104 mm) and 18 pieces of cathodes (195 μm, 110 mm by 100 mm) and polyethylene separators is constructed. Anodes are pre-lithiated for 22 hours in 1.2 molar LiPF₆ in the mixture comprising EC/DMC/EMC (3/3/4), which also contains 2% ES. This results in the formation of a passivation film layer by reduction reactions.

The cell is then filled with 100 g of 1.2 molar LiPF₆ in the mixture of EC/DMC/EMC (3/3/4) with 1% MEC and 1% PS, which repairs the first SEI layer and forms the second SEI layer. After 15 minutes, 2.1 g of HMDS is added to remove any trace water contaminations. After cell ageing, the excess electrolyte is poured out, and the cell is resealed.

### Example 3

The preparation method and structure of this cell is similar to that of example 2 except the pre-lithiation time and the amount of HMDS. The pre-lithiation time is 23 hours and the amount of HMDS added is 0.7 g.

### Example 4

A LiC comprising 18 pieces of anodes (150 μm, 110 mm by 105 mm) and 17 pieces of cathodes (195 μm, 105 mm by 100 mm) and polyethylene separators is constructed. Anodes are pre-lithiated for 22 hours in 1.2 molar LiPF₆ in the mixture of EC/DMC/EMC (3/3/4) containing 2% ES, which results in the formation of passivation film layer by reduction reactions.

The cell is filled with 77 g of 1.2 molar LiPF₆ in the mixture of EC/DMC/EMC (3/3/4) containing 3% FEC, which results in the formation of a second SEI layer (polymerization layer).

### Example 5

A LiC comprising 2 pieces of anodes (150 μm, 105 mm by 95 mm) and one piece of cathode (200 μm, 100 mm by 90 mm) is constructed. The pre-lithiating electrolyte is 1.2 molar LiPF₆ in the mixture of EC/DMC/EMC (3/3/4) containing 2% ES, and the filled electrolyte is 1.0 molar LiPF₆ in the mixture of EC/DMC/EMC (3/3/4) containing 2% MEC additive for forming polymerization SEI layers.

### Comparative Example 1

A LiC comprising pieces of anodes (150 μm, 115 mm by 104 mm), 10 pieces of cathodes (275 μm, 110 mm by 100 mm) and polyethylene separators is constructed. The pre-doping electrolyte is 1.0 molar LiPF₆ in the mixture of EC/DMC/EMC (3/3/4) containing 2% VC, and the pre-lithiation time is 19.5 hours. The cell is filled with 68.5 g of 1.2 molar LiPF₆ in the mixture of EC/DMC/EMC (3/3/4).

### Comparative Example 2

A LiC comprising 11 pieces of anodes (150 μm, 115 mm by 104 mm), 10 pieces of cathodes (275 μm, 110 mm by 100 mm) and polyethylene separators is constructed. The pre-doping electrolyte is 1.2 molar LiPF₆ in the mixture of EC/DMC/EMC (3/3/4) containing 3% ES for pre-lithiation, and the pre-lithiation time is 22 hours. The cell is filled with 65 g of 1.2 molar LiPF₆ in the mixture of EC/DMC/EMC (3/3/4).

### Comparative Example 3

A LiC comprising 11 pieces of anodes (150 μm, 115 mm by 104 mm), 10 pieces of cathodes (275 μm, 110 mm by 100 mm) and polyethylene separators is constructed. The pre-doping electrolyte is 1.0 molar LiPF₆ in the mixture of EC/DMC/EMC (3/3/4) with 2% VC, and the pre-lithiation time is 23 hours. The cell was filled with 70 g of 1.0 molar LiPF₆ in the mixture of EC/DMC/EMC (3/3/4) with 2% VC and 2.1 g of HMDS.

### Comparative Example 4

LICs consist of 2 pieces of anodes (160 microns, 107×97 mm) and one cathode (200 microns, 105×95 mm). The pre-doping electrolyte is 1.0 M LiPF₆ in EC/DMC/EMC (3/3/4) with 2% MEC, and the pre-doping time is 15 h. Each cell was filled with 12 g of 1.0 M LiPF₆ in EC/DMC/EMC (3/3/4) with 2% MEC.

TABLE 1
Equivalent series resistance and capacitance of exemplary lithium ion
capacitors

| | initial | initial | | ESR change | capacitance |
|---|---|---|---|---|---|
| | ESR | capacitance | cycle | [%] after | change [%] |
| | [mΩ] | [F] | number | cycling | after cycling |
| Example 1 | 4.6 | 1416 | 280,000 | −23.5% | 3.9% |
| Example 2 | 2.23 | 1769 | 96,000 | −2.8% | 2.1% |
| Example 3 | 2.28 | 1724 | 100,000 | −12.4% | 5.6% |
| Example 4 | 2.34 | 1517 | 100,000 | 1.2% | −2.3% |
| Example 5 | 64.4 | 81 | 100,000 | −6.1% | 3.1% |
| Comparative | 2.43 | 1629 | 4,000 | 14.2% | −7.8% |
| example 1 | | | | | |
| Comparative | 4.59 | 1424 | 40,000 | 50.9% | 2.4% |
| example 2 | | | | | |
| Comparative | 3.75 | 1491 | 100,000 | 8.9% | −7.4% |
| example 3 | | | | | |
| Comparative | 86.9 | 72 | 100,000 | 1.1% | 14.6% |
| example 4 | | | | | |

Table 1 lists initial ESR and capacitance values of LiCs and their performance changes after a certain cycle number. It can be seen that the cells of from example 1 to example 5 have good capacitance retention rates, and that only the cell from example 4 has a slight capacitance drop. As for ESR, only the cell from example 4 has 1.2% of ESR gain, and the other cells have ESR decreasing after cycling. This indicates that the cells that have good performance can attribute their performance to stable the engineered SEI formed by the two-step method. The SEI with the engineered hierarchy structure is better at preventing electrolyte decomposition, and thus reduced gas generation.

The cells of comparative example 1 have polymerization layer formed by VC additive. Although the cells have low initial ESR and capacitance, their ESRs increase by 14.2% after 4000 cycles, and their capacitances reduce by 7.8% after the same number of cycles. After 4000 cycles, the cells significantly swell due to electrolyte decomposition and subsequent gas generation.

For comparative example 2, although the cells have a 2.4% of capacitance gain after 40000 cycles, their ESRs increase by 50.9% after the same number of cycle. This can be attributed to the thickness increase in passivation layers formed due to the ES additive.

Comparative example 3 shows that the cells' performance has improved by forming a thick enough SEI by the addition of the VC additive. Compared to examples 1-5, the cells of comparative example 3 have lower performance. Their ESRs increase by 8.9%, and their capacitances decrease by 7.4% after 100,000 cycles.

The cells of comparative example 4 show 1.1% ESR gain after 100,000 cycles. This may be due to the compact SEI formed by MEC which suppresses electrolyte decomposition. However, the cells have the highest capacitance gain compared to any other examples. This can be contributed to the SEI structure adjustment which leads to the formation of SEI with high lithium ion conductivity.

Based on the results of these example cells, the cells with SEI layers formed by a hierarchy method using multiple additives have demonstratively shown to have better performance than the cells with SEI layers formed alone by either of the passivation type of additives or the polymerization type of additives.

1. An electrochemical energy storage device comprising:
a cathode;
a pre-lithiated anode having an engineered solid electrolyte interphase disposed thereon;
a separator disposed between the cathode and the pre-lithiated anode; and
an electrolyte including an electrolyte additive.

2. The electrochemical energy storage device of claim 1, wherein the pre-lithiated anode comprises at least one of silicon, bismuth, boron, gallium, indium, zinc, tin, antimony, aluminum, titanium oxide, molybdenum, germanium, manganese, niobium, vanadium, tantalum, iron, copper, gold, silver, platinum, chromium, nickel, cobalt, zirconium, yttrium, molybdenum oxide, germanium oxide, silicon oxide, silicon carbide, alloys thereof, and any combination thereof.

3. The electrochemical energy storage device of claim 1, wherein the pre-lithiated anode having the engineered solid electrolyte interphase disposed thereon comprises a lithium salt.

4. The electrochemical energy storage device of claim 3, wherein the lithium salt includes at least one of lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃), and mixtures thereof.

5. The electrochemical energy storage device of claim 1, wherein the separator is a polymer film.

6. The electrochemical energy storage device of claim 5, wherein the separator is a polyethylene film attached to a surface of the cathode.

7. The electrochemical energy storage device of claim 1, wherein the cathode and the pre-lithiated anode are each electrodes.

8. The electrochemical energy storage device of claim 7, wherein the electrodes have form factor including of at least one of flat, rolled, or multilayer electrode stack.

9. The electrochemical energy storage device of claim 7, wherein the electrodes comprise a carbon based electrode material including at least one of graphene, graphene sheets, aggregates of graphene sheets, graphite, graphitic carbon, non-graphitic carbon, amorphous carbon, mesocarbon microbeads, boron-carbon alloys, hard carbon, disordered carbon, carbon nanotubes, nitrogen-doped graphene, mixtures thereof, composites thereof, and any combination thereof.

10. The electrochemical energy storage device of claim 7, wherein the electrodes comprise at least one of silicon, tin, tin oxide, iron oxide, cobalt oxide, copper oxide, titanium oxide, molybdenum oxide, germanium oxide, silicon oxide, lithium titanium oxide (lithium titanate), chalcogenides, lead sulfide, tantalum sulfide, molybdenum sulfide, tungsten sulfide, sulfur mixtures thereof, alloys thereof, and any combination thereof.

11. The electrochemical energy storage device of claim 7, wherein the electrolyte additive comprises an organic solvent.

12. The electrochemical energy storage device of claim 11, wherein the organic solvent includes at least one of ethyl carbonate (EC), fluoroethylene carbonate (FEC), and vinylene carbonate (VC), dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, 1-fluoro-2-(methylsulfonyl) benzene, and mixtures thereof.

13. The electrochemical energy storage device of claim 7, wherein the electrolyte additive is a functional type additive.

14. The electrochemical energy storage device of claim 13, wherein the functional type additive forms a passivation layer on the electrodes.

15. The electrochemical energy storage device of claim 14, wherein the functional type additive comprises a sulfur-containing chemical.

16. The electrochemical energy storage device of claim 15, wherein the sulfur-containing chemical is at least one of ethylene sulfite (ES), propylene sulfite (PS), dimethyl sulfite (DMS), and combinations thereof.

17. The electrochemical energy storage device of claim 7, wherein the electrolyte additive is a polymerization type additive.

18. The electrochemical energy storage device of claim 17, wherein the polymerization type additive is ethyl carbonate (EC), fluoroethylene carbonate (FEC), and vinylene carbonate (VC).

19. The electrochemical energy storage device of claim 17, wherein the polymerization type additive forms a polymerization layer on the electrodes.

20. The electrochemical energy storage device of claim 19, wherein the polymerization layer comprises at least one of ethyl carbonate (EC), fluoroethylene carbonate (FEC), and vinylene carbonate (VC), dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, 1-fluoro-2-(methylsulfonyl) benzene, and mixtures thereof.

21. The electrochemical energy storage device of claim 19, wherein the polymerization layer comprises a lithium salt.

22. The electrochemical energy storage device of claim 21, wherein the lithium salt comprises at least one of lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), lithium monocarbon trifluorosulfite (LiCF₃SO₃), and mixtures thereof.

23. The electrochemical energy storage device of claim 1, wherein the electrochemical energy storage device is a lithium-ion capacitor (LiC).

24.-46. (canceled)

47. A method of forming an engineered solid electrolyte interphase for an electrochemical energy storage device comprising:
providing an electrolyte, a first electrode and a second electrode, the first electrode having excess of lithium ions relative to the second electrode;
adding an additive to an electrolyte; and
forming the engineered solid electrolyte interphase on the first electrode and the second electrode.

48. The method of claim 47, wherein the first electrode is a pre-lithiated anode and the second electrode is a cathode.

49. The method of claim 48, wherein the pre-lithiated anode comprises at least one of silicon, bismuth, boron, gallium, indium, zinc, tin, antimony, aluminum, titanium oxide, molybdenum, germanium, manganese, niobium, vanadium, tantalum, iron, copper, gold, silver, platinum, chromium, nickel, cobalt, zirconium, yttrium, molybdenum oxide, germanium oxide, silicon oxide, silicon carbide, alloys thereof, and any combination thereof.

50. The method of claim 48, wherein the pre-lithiated anode comprises a lithium salt.

51. The method of claim 50, wherein the lithium salt includes at least one of lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), and lithium monocarbon trifluorosulfite (LiCF₃SO₃), and mixtures thereof.

52. The method of claim 47, wherein the first electrode and the second electrode each comprise a carbon based electrode material including at least one of graphene, graphene sheets, aggregates of graphene sheets, graphite, graphitic carbon, non-graphitic carbon, amorphous carbon, mesocarbon microbeads, boron-carbon alloys, hard carbon, disordered carbon, carbon nanotubes, nitrogen-doped graphene, mixtures thereof, composites thereof, and any combination thereof.

53. The method of claim 47, wherein the first electrode and the second electrode each comprise at least one of silicon, tin, tin oxide, iron oxide, cobalt oxide, copper oxide, titanium oxide, molybdenum oxide, germanium oxide, silicon oxide, lithium titanium oxide (lithium titanate), chalcogenides, lead sulfide, tantalum sulfide, molybdenum sulfide, tungsten sulfide, sulfur mixtures thereof, alloys thereof, and any combination thereof.

54. The method of claim 47, wherein the electrolyte additive comprises an organic solvent.

55. The method of claim 54, wherein the organic solvent includes at least one of ethyl carbonate (EC), fluoroethylene carbonate (FEC), and vinylene carbonate (VC), dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, 1-fluoro-2-(methylsulfonyl) benzene, and mixtures thereof.

56. The method of claim 47, wherein the electrolyte additive is a functional type additive.

57. The method of claim 56, wherein the functional type additive forms a passivation layer on the first electrode and the second electrode.

58. The method of claim 56, wherein the functional type additive comprises a sulfur-containing chemical.

59. The method of claim 58, wherein the sulfur-containing chemical is at least one of ethylene sulfite (ES), propylene sulfite (PS), dimethyl sulfite (DMS), and combinations thereof.

60. The method of claim 47, wherein the electrolyte additive is a polymerization type additive.

61. The method of claim 60, wherein the polymerization type additive is ethyl carbonate (EC), fluoroethylene carbonate (FEC), and vinylene carbonate (VC).

62. The method of claim 60, wherein the polymerization type additive forms a polymerization layer on the first electrode and the second electrode.

63. The method of claim 62, wherein the polymerization layer comprises at least one of ethyl carbonate (EC), fluoroethylene carbonate (FEC), and vinylene carbonate (VC), dimethyl carbonate (DMC), ethylene methyl carbonate (EMC), diethyl carbonate (DEC), propylene carbonate (PC), γ-butyrolactone (GBL), methyl formate, ethyl formate, ethylmethyl sulfone, ethyl acetate, ethyl butyrate, methyl propionate, ethylmethyl sulfone, butyl sulfone, 1-fluoro-2-(methylsulfonyl) benzene, and mixtures thereof.

64. The method of claim 62, wherein the polymerization layer comprises a lithium salt.

65. The method of claim 64, wherein the lithium salt comprises at least one of lithium hexafluorophosphate (LiPF₆), lithium tetrafluoroborate (LiBF₄), lithium perchlorate (LiClO₄), lithium bis(oxalato) borate (LiBOB), lithium hexafluoroarsenate (LiAsF₆), lithium monocarbon trifluorosulfite (LiCF₃SO₃), and mixtures thereof.

66. The method of claim 62, wherein the polymerization layer is formed at a reducing condition.

67. The method of claim 47, wherein the electrochemical energy storage device is a lithium-ion capacitor (LiC).

68.-113. (canceled)
